(19) United States
(12) Patent Application Publication
(10) Pub. No.: US 2010/0283695 A1
(43) Pub. Date: Nov. 11, 2010

(54) Waveguide Lens Antenna

(76) Inventor: Erik Geterud, Pixbo (SE)

Correspondence Address: DOWNS RACHLIN MARTIN PLLC, 199 MAIN STREET, P O BOX 190, BURLINGTON, VT, 05402-0190, US

(21) Appl. No.: 12/738,448

(22) PCT Filed: Dec. 21, 2007
(86) PCT No.: PCT/GB07/50783

§ 371 Date: Jul. 9, 2010

(30) Foreign Application Priority Data
Oct. 16, 2007 (GB) 0720197.3

(51) Int. Cl. H01Q 19/06

(52) U.S. Cl. 343/753

(57) ABSTRACT

A waveguide lens antenna (WGLA) with especially wideband characteristics. The geometry of the WGLA is shaped to result in ideal phase shift over a maximum bandwidth. The specific convex shape makes it possible to modulate the phase of all waveguides to generate a plane wave over a much wider frequency band than has earlier been possible. The waveguides are circular symmetric oriented which result in a favourable S-parameter matrix and low cross polar level. The WGLA have scanning properties i.e. provide multiple beams by moving the feeds on the focal plane behind the WGLA.

The present invention relates to a waveguide lens antenna, particularly, but not limited to, a wideband convex waveguide antenna.

The idea of focusing a plane electro magnetic wave using Fresnel zones evolved from work on interference and diffraction of light done by the French engineer Augostin Fresnel. Fresnel derived the concept of half period zones and showed that light from adjacent “Fresnel” zones would be in phase opposition. In 1875, Jacques-Louis Soret published the first paper on optical Fresnel zone plates, as discussed in History and evolution of Fresnel Zone Plate Antennas for Microwaves and Millimeter waves. James C. Wiltse IEEE Transactions on Antennas and propagation, 1999.

Fresnel zone plates for microwave frequencies were presented the first time in a US patent by A. G. Clavier and R. H. Darbord in 1936 where wavelength of 20 cm (1.5 GHz) was mentioned.

In the 1930s to 1960s progress was made and half open and phase correction zone plates were introduced. Furthermore, high permittivity dielectrics, in order to reduce thickness and weight of the plates, were suggested.

In the second half of the 1940s metal plate microwave lens antennas have been presented in three different papers, see, for example, M. Hamidi, J. Withington, E Wiswell., “Deployable Microwave Lens Antenna”, IEEEAC paper nr 350, 2002.

In the last decade one has noticed an increased interest in Fresnel zone plates and research has been conducted in Europe, Asia and North America. It has been found to be an interesting and flexible alternative to reflector antennas in e.g. space applications.

The concept of the waveguide lens antenna technique is based on the fact that between two metallic plates parallel to the electric vector, the phase velocity of electromagnetic waves is greater than in air, thus creating an index of refraction less than one, n<1, giving concave properties. By arranging a number of metallic plates, or waveguides, in a proper profile an optical device which transforms spherical waves to planar wave fronts is formed.

Conventional waveguide lenses based on equal phase delay are very frequency sensitive because of the large difference in time delay between centre and edge rays.

According to the present invention there is provided an apparatus and method as set forth in the appended claims. Other features of the invention will be apparent from the dependent claims, and the description which follows.

According to a first aspect of the present invention there is provided a waveguide lens comprising a plurality of waveguides, the lens being adapted to focus an incoming wavefront to a chosen focal plane and to blur an outgoing wave front emitted from the focal plane, wherein each waveguide comprises a waveguide pipe, said waveguide pipes having longitudinal axes arranged substantially parallel to each other.

By blur it should be understood that a plane wave is created that in its far field concentrates the energy within a small conical angle.

The waveguide pipes are preferably hollow. The waveguide pipes are preferably substantially square in cross-section. The waveguide pipes preferably have an electrically conducting coating on at least one of an interior or an exterior surface thereof.

The waveguides may incorporate at least one waveguide horn, preferably a waveguide horn at each end of the waveguide pipe. Said waveguide horn preferably has an electrically conducting coating on side walls thereof. Some waveguides may have no waveguide horns.

The waveguide horns preferably flare away from the ends of the waveguide pipe. Preferably, the waveguide horns flare in both directions perpendicular to the axis of the waveguide pipe.

The waveguide horns are preferably made of solid material, for example expanded polystyrene.

The waveguide lens is preferably a wideband waveguide lens, preferably adapted to transmit and receive over a frequency range of substantially 10.75 GHz to 14.5 GHz. Preferably, the lens has an operating range, defined by (fmax−fmin/fcentre)*100, in the range 10% to 40%, more preferably 15% to 35% more preferably 18% to 30%, where fmax is the maximum operating frequency, fmin the minimum operating frequency, fcentre the central frequency.

The waveguide lens is preferably a convex waveguide lens, preferably being convex on both sides thereof.

Preferably, the waveguides are arranged in rings centred on a central axis of the lens. The rings are preferably concentric. The waveguides may have a linear, or side-by-side, arrangement in a central section of the lens, in order to achieve closer packing of the waveguides.

Preferably, the rings of waveguides, or zones, have equal time delay in each zone.

According to another aspect of the invention there is provided a waveguide lens comprising a plurality of waveguides, wherein the waveguide lens is adapted to focus an incoming wavefront to a focal space, to thereby cause different frequencies of incoming wavefront to be focused to substantially the same focal space.

The advantageous focusing, or allowing of some blurring, allows multiple frequencies to be picked up by a horn located in the focal space.

The invention extends to an assembly of a waveguide lens and at least one horn. Preferably, the horn has phase centres that substantially coincide with the focal space of the waveguide lens.

For a better understanding of the invention, and to show how embodiments of the same may be carried into effect, reference will now be made, by way of example, to the accompanying diagrammatic drawings in which:

FIG. 1 is a schematic side view of a wideband convex waveguide antenna showing schematically the passage of waves therethrough;

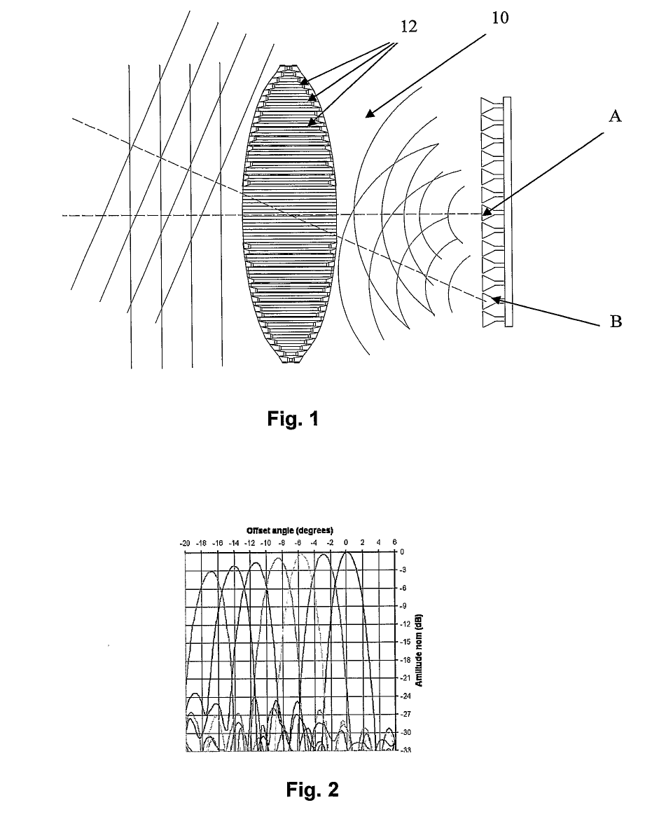

FIG. 2 shows a graph of amplitude of received signal for the antenna of FIG. 1 at a given offset from a central axis thereof;

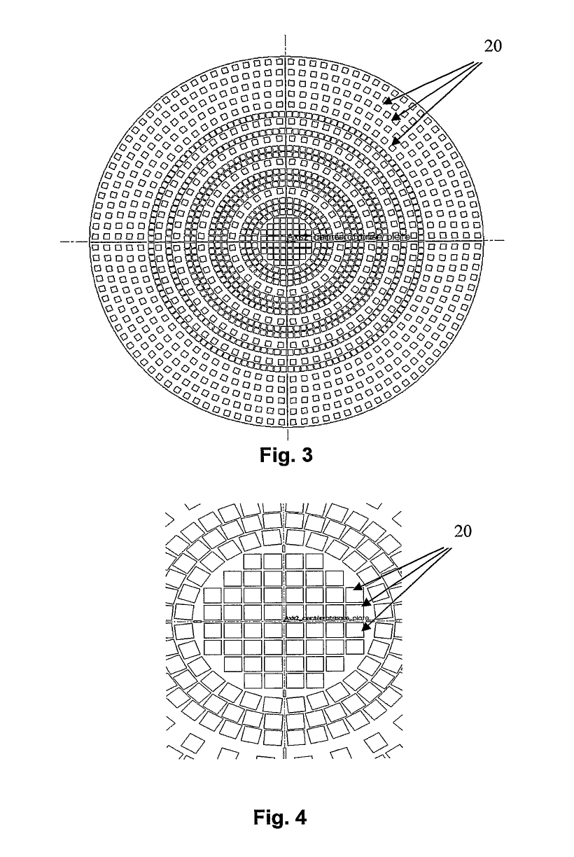

FIG. 3 is a schematic front view of a superstructure of the waveguide antenna;

FIG. 4 is a schematic detail of the superstructure of FIG. 3;

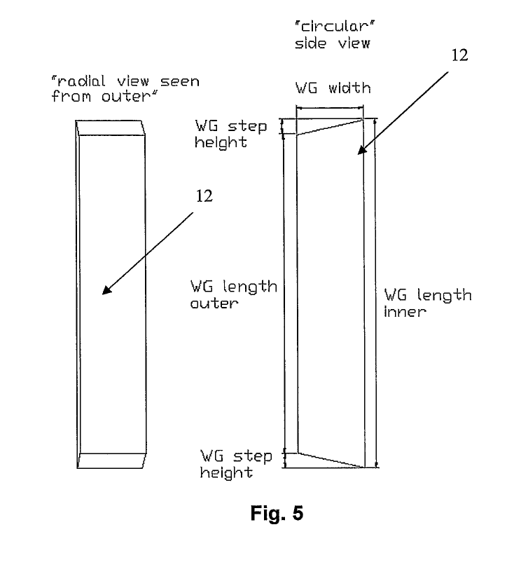

FIG. 5 shows schematic outer and side views of waveguide pipes of the antenna; and

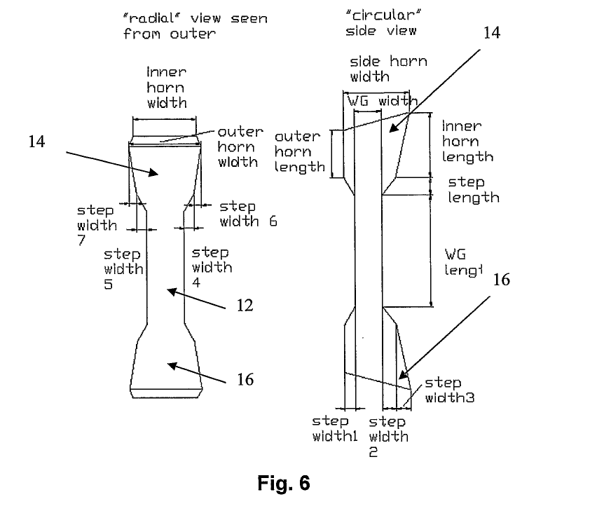

FIG. 6 shows schematic side and outer views of the waveguide pipes with horns attached.

The wideband convex waveguide lens antenna (WGLA) 10 shown in FIG. 1 comprises an array consisting of rectangular waveguides 12 in a rotationally symmetric arrangement around a central axis of the antenna. The phase modulation of the lens results in that an incoming plane wave is focused to one point (e.g. A or B) on the focal plane [FIG. 1] and the location of the focal point depending on the origin of the incoming plane wave.

FIG. 1 shows schematically antenna signal transmission/reception. A spherical wave generated from a source (e.g. a feed horn) in the focal plane is transformed to a plane wave. Beam direction depends on source position in the focal plane. The antenna system is reciprocal i.e. can work in transmit or receive mode.

A lens can be zoned in order to minimize thickness and weight or to minimize aperture phase error. In this patent focus has been set to minimize the aperture phase error over a maximum bandwidth. The aperture phase error refers to the phase variation from the ideal plane wave front when leaving the antenna aperture. The phase error degrades the antenna performance, i.e. reducing the gain and increasing the side lobes, and must therefore be minimized. A source of aperture error in the antenna can be tolerances i.e. variations in waveguide dimensions when manufactured. Between zones, which can also be referred to as Fresnel steps, there is a phase difference of n*zπ (n=integer) so the waves reach the focal point in phase and interfere constructively.

For large bandwidth we require equal, or nearly so, group delay for all rays independent of frequency from the focal point of the lens to the aperture plane. Conventional waveguide lenses based on equal phase delay are very frequency sensitive because of the large difference in time delay between centre and edge rays.

Zoning a lens to minimize weight produces an aperture phase distribution at off design frequency that is saw tooth with a mean value that increase quadratically from the centre of the lens to the edge.

In this patent description we are adding thickness to the centre of the lens creating a convex geometry. By doing this we increase the number of zones and generate equal time delay in each zone. This results in an aperture distribution at frequencies of the design frequency which has a mean error zero. By increasing the thickness of the lens there is an extra degree of freedom in the design compared to antenna designs with zero centre thickness. By combining correct waveguide lengths with correct waveguide widths it is possible to extend the operating frequency bandwidth from 1.17:1 to 1.3:1 or 17% to 30%. The bandwidth is calculated as the operational frequency band divided with the centre frequency as (fmax−fmin)/fcentre*100%.

The antenna is made in an optimized convex shape and contains several Fresnel steps which down steps the lens from its centre thickness to its ideal zero thickness at the edges. The phase velocity of the electromagnetic wave is increased to a value higher than that of free space (c) in the waveguides. For a specific waveguide dimension the phase velocity of the fundamental operating TE₁₀ mode is infinity i.e. at the cut off frequency. Below the cut off frequency the wave cannot propagate inside the waveguide. The increase in phase velocity is inversely proportional to increase in frequency. By shaping the lens to an optimized convex geometry it is possible to obtain a 1.3:1 or 30% bandwidth. Conventional lenses defocus i.e. the F/D ratio increase with frequency, which results in reduced bandwidth. However the shaped convex WGLA with variable waveguide widths minimises the defocusing and therefore also increases the bandwidth.

A spherical wave generated from a source at the focus is transformed into a plane wave perpendicular to the lens axis when the ray paths in radians are constant (k) for all cases:

$$2 \prod [ \frac{{D}_{1}}{{λ}_{0}} + \frac{{D}_{2}}{{λ}_{g}} + \frac{{D}_{3}}{{λ}_{0}} + d ] = k$$

D₁: distance feed to lens surface
D₂: distance through lens parallel to lens axis
D₃: distance lens surface to aperture plane
d=integer
λ_{g}=guide wavelength

The index of refraction can be specified by:

n=[1−(λ/λ_{c})²]^{1/2}

Where λ_{c} is the cut off wavelength in the waveguide.

The circular symmetrical shape of the antenna results in a controlled electromagnetic behaviour with minimised cross polarization. The symmetry also results in equal radiation patterns in all planes of the antenna (also referred to as a BOR₁ Body of Revolution antenna).

The waveguides are made of extruded ABS waveguide tubes that are plated or copper painted. The antenna is therefore very light weight and the old problem of heavy metal plate antennas is overcome.

The antenna has multi beam properties and depending on size of the antenna, which determines gain and focal length, feed separation of down to 2° and even lower can be obtained. Maximum scan angle also depending on antenna size but ±20° with sufficient performance is possible for VSAT stations. Multi beam communication with several feed horns placed on the focal plane was illustrated in FIG. 1 and the resulting main lobes of a compact 80 cm WGLA is shown in FIG. 2.

Below follows a description of the antenna geometry. The positions of the individual waveguides are stated as well as detailed data of the waveguide dimensions. All waveguides are equally spaced in circular arrays, except in the central section, see for example FIGS. 1, 5a, 5b.

FIG. 3 shows a superstructure that holds the waveguides in position in square openings 20. In table 1 the openings are labelled by ring number, starting at the outer ring, numbered P1.

Tables 1 to 3 show various dimensions for the superstructure and waveguides for a waveguide antenna with a diameter of 120 cm. Tables 4 to 6 give corresponding dimensions for a 170 cm diameter waveguide antenna.

FIG. 4 shows a detail of the centre of the waveguide superstructure, to show the deviation from the ring structure mentioned above.

FIGS. 5 and 6 show the shape of the waveguides used. Each waveguide 10 consists of a pipe 12 with a square cross-section and sloping ends. The slope is defined in FIG. 5 and the values are given in Table 2. Most of the pipes 12 (except those referred to as Type WG in Table 1) have waveguide horns 14, 16. The waveguide horns have the dimensions shown in FIG. 6 with the values set out in Table 3.

TABLE 1
Array data. Position and length of antenna
waveguide elements.

| | | | | | Outer | Inner |
|---|---|---|---|---|---|---|
| Nr. | R | Units | Ang sep. | Type | length | length |
| P1 | 586.5 | 108 | 3.33 | H | 143 | 172 |
| P2 | 551.53 | 100 | 3.60 | H | 176 | 207 |
| P3 | 516.43 | 92 | 3.91 | H | 211 | 241 |
| P4 | 481.5 | 84 | 4.29 | H | 245 | 259 |
| P5 | 446.68 | 80 | 4.50 | H | 263 | 275 |
| P6 | 414.65 | 128 | 2.81 | WG | 276 | 284 |
| P7 | 391.58 | 68 | 5.29 | H | 285 | 297 |
| P8 | 359.6 | 112 | 3.21 | WG | 298 | 312 |
| P9 | 336.48 | 56 | 6.43 | H | 312 | 321 |
| P10 | 304.6 | 92 | 3.91 | WG | 321 | 331 |
| P11 | 284.5 | 88 | 4.09 | WG | 331 | 339 |
| P12 | 261.18 | 44 | 8.18 | H | 341 | 351 |
| P13 | 229.63 | 72 | 5.00 | WG | 351 | 356 |
| P14 | 209.63 | 64 | 5.63 | WG | 356 | 361 |
| P15 | 189.65 | 56 | 6.43 | WG | 361 | 366 |
| P16 | 166 | 28 | 12.86 | H | 366 | 370 |
| P17 | 134.78 | 40 | 9.00 | WG | 370 | 370 |
| P18 | 116.28 | 36 | 10.00 | WG | 370 | 370 |
| P19 | 96.88 | 28 | 12.86 | WG | 370 | 370 |
| P20 | Linear | | | | 370 | 370 |
| P21 | Linear | | | | 370 | 370 |
| P22 | Linear | | | | 370 | 370 |
| P23 | Linear | | | | 370 | 370 |
| P24 | Linear | | | | 370 | 370 |

In the table the columns show:

R—Radial position of waveguide [mm];
Nr—Array number. E.g. P1 is position of outermost waveguide;
Units—Amount of waveguides in circular pattern for specific array number;
Ang separation—Angular spacing between consecutive waveguides. [deg];
Type-H—Horn shaped waveguide aperture;
Type-WG—Narrow waveguide aperture;
Outer length—Waveguide length (outer dimension of profile) [mm]—see FIGS. 5 and 6;
Inner length—Waveguide length (inner dimension of profile) [mm]—see FIGS. 5 and 6.

TABLE 2
Waveguide dimensions

| | WGLO | WGLI | WGW | WGSH |
|---|---|---|---|---|
| P6 | 275 | 283 | 17.2 | 4 |
| P8 | 297 | 311 | 17.1 | 7 |
| P10 | 321 | 331 | 17 | 5 |
| P11 | 331 | 339 | 17.5 | 4 |
| P13 | 351 | 356 | 16.9 | 2.5 |
| P14 | 356 | 361 | 17.4 | 2.5 |
| P15 | 361 | 366 | 17.7 | 2.5 |
| P17 | 370 | 370 | 16.8 | 0 |
| P18 | 370 | 370 | 16.9 | 0 |
| P19 | 370 | 370 | 16.9 | 0 |
| P20 | 370 | 370 | 17 | 0 |
| P21 | 370 | 370 | 17 | 0 |
| P22 | 370 | 370 | 17.1 | 0 |
| P23 | 370 | 370 | 17.1 | 0 |
| P24 | 370 | 370 | 17.1 | 0 |

In Table 2 above the columns are labelled as follows (see FIGS. 5 and 6 for the dimensions referred to):

WGLO—Waveguide length outer;
WGL1—Waveguide length inner;
WGW—Waveguide width; and
WGSH—Waveguide step height.

The dimensions of waveguides with horn apertures are stated in table 3—see FIG. 6 for the dimensions referred to.

TABLE 3
Dimensions of waveguides with horn apertures

| | | P1 | P2 | P3 | P4 | P5 | P7 | P9 | P12 | P16 |
|---|---|---|---|---|---|---|---|---|---|---|
| WG-length: | WGL | 50.6 | 80.8 | 117 | 153.6 | 174.4 | 183.6 | 222.4 | 250.4 | 272.8 |
| Step | SL | 11 | 11 | 11 | 11 | 11 | 11 | 11 | 11 | 11 |
| length: | | | | | | | | | | |
| Inner horn | IHL | 51.6 | 53.1 | 52.6 | 42.6 | 40.1 | 40.1 | 38.1 | 38.6 | 35.6 |
| length: | | | | | | | | | | |
| 0uter horn | OHL | 35.2 | 36.6 | 36.1 | 34.7 | 33.3 | 33.3 | 33.8 | 34.3 | 35.6 |
| length: | | | | | | | | | | |
| Side horn | SHW | 33.7 | 33.9 | 33.8 | 32.5 | 32.2 | 32.2 | 30.7 | 30.7 | 30.4 |
| width: | | | | | | | | | | |
| Inner horn | IHW | 32.8 | 33 | 33 | 33.9 | 33.5 | 33.5 | 33.5 | 33.6 | 33.1 |
| width: | | | | | | | | | | |
| Outer horn | OHW | 34.2 | 34.5 | 34.4 | 36.1 | 35.8 | 35.8 | 37.2 | 37.2 | 37.7 |
| width: | | | | | | | | | | |
| WG width: | WGW | 17.6 | 17.4 | 17.3 | 17 | 16.5 | 16.4 | 16.4 | 16.8 | 17 |
| Step | SW1 | 4.2 | 4.2 | 4.2 | 4.2 | 4.2 | 4.2 | 4.2 | 4.2 | 4.2 |
| width1: | | | | | | | | | | |
| Step width | SW2 | 5.6 | 5.6 | 5.6 | 5.6 | 5.6 | 5.6 | 5.6 | 5.6 | 5.6 |
| 2: | | | | | | | | | | |
| Step width | SW3 | 8 | 5.3 | 7.1 | 5.5 | 5.2 | 5.2 | 3.7 | 3.7 | 3.4 |
| 3: | | | | | | | | | | |
| Step width | SW4 | 5.8 | 5.8 | 5.8 | 5.8 | 5.8 | 5.8 | 5.8 | 5.8 | 5.8 |
| 4: | | | | | | | | | | |
| Step width | SW5 | 5.8 | 5.8 | 5.8 | 5.8 | 5.8 | 5.8 | 5.8 | 5.8 | 5.8 |
| 5: | | | | | | | | | | |
| Step width | SW6 | 4.2 | 4.2 | 4.2 | 4.2 | 4.2 | 4.2 | 4.2 | 4.2 | 4.2 |
| 6: | | | | | | | | | | |
| Step width | SW7 | 4.2 | 4.2 | 4.2 | 4.2 | 4.2 | 4.2 | 4.2 | 4.2 | 4.2 |
| 7: | | | | | | | | | | |

TABLE 4
Array data for 170 cm antenna. Position and length
of antenna waveguide elements.

| | | | | | Outer | Inner |
|---|---|---|---|---|---|---|
| Nr. | R | Units | Ang sep. | Type | length | length |
| P1 | 844.7 | 156 | 2.30 | H | 100 | 142 |
| P2 | 810.2 | 150 | 2.40 | H | 142 | 194 |
| P3 | 775.7 | 143 | 2.51 | H | 194 | 246 |
| P4 | 741.2 | 137 | 2.63 | H | 246 | 292 |
| P5 | 706.7 | 131 | 2.75 | H | 292 | 322 |
| P6 | 672.2 | 124 | 2.90 | H | 322 | 352 |
| P7 | 637.7 | 118 | 3.05 | H | 352 | 378 |
| P8 | 610.45 | 197 | 1.83 | WG | 378 | 390 |
| P9 | 583.2 | 108 | 3.34 | H | 390 | 410 |
| P10 | 548.7 | 101 | 3.55 | H | 410 | 430 |
| P11 | 521.45 | 168 | 2.14 | WG | 430 | 440 |
| P12 | 494.2 | 91 | 3.94 | H | 440 | 456 |
| P13 | 466.95 | 150 | 2.39 | WG | 456 | 464 |
| P14 | 439.7 | 81 | 4.42 | H | 464 | 478 |
| P15 | 412.45 | 133 | 2.71 | WG | 478 | 484 |
| P16 | 385.2 | 71 | 5.04 | H | 484 | 496 |
| P17 | 357.95 | 115 | 3.12 | WG | 496 | 502 |
| P18 | 337.95 | 109 | 3.30 | WG | 502 | 508 |
| P19 | 317.95 | 102 | 3.51 | WG | 508 | 514 |
| P20 | 290.7 | 54 | 6.67 | H | 514 | 522 |
| P21 | 263.45 | 85 | 4.23 | WG | 522 | 528 |
| P22 | 243.45 | 78 | 4.58 | WG | 528 | 534 |
| P23 | 216.2 | 40 | 8.94 | H | 534 | 542 |
| P24 | 181.7 | 34 | 10.60 | H | 542 | 550 |
| P25 | 154.9 | 52 | 6.85 | WG | 550 | 550 |
| P26 | 135.75 | 46 | 7.84 | WG | 550 | 550 |
| P27 | 116.5 | 39 | 9.17 | WG | 550 | 550 |
| P28 | 97.2 | 32 | 10.95 | WG | 550 | 550 |
| P29 | 77.85 | 26 | 13.65 | WG | 550 | 550 |
| P30 | 58.45 | 19 | 17.92 | WG | 550 | 550 |
| P31 | 39 | 13 | 25.97 | WG | 550 | 550 |
| P32 | 19.5 | 6 | 44.26 | WG | 550 | 550 |
| P33 | 0 | 0 | 0 | WG | 550 | 550 |

In the table the columns show:

R—Radial position of waveguide [mm];
Nr—Array number. E.g. P1 is position of outermost waveguide;
Units—Amount of waveguides in circular pattern for specific array number;
Ang separation—Angular spacing between consecutive waveguides. [deg];
Type-H—Horn shaped waveguide aperture;
Type-WG—Narrow waveguide aperture;
Outer length—Waveguide length (outer dimension of profile) [mm]—see FIGS. 5 and 6;
Inner length—Waveguide length (inner dimension of profile) [mm]—see FIGS. 5 and 6.

TABLE 5
170 cm Waveguide dimensions

| | WGLO | WGLI | WGW | WGSH |
|---|---|---|---|---|
| P8 | 378 | 389 | 17.9 | 5.5 |
| P11 | 430 | 439 | 17.5 | 4.5 |
| P13 | 456 | 463.6 | 17.5 | 3.8 |
| P15 | 478 | 483 | 17.3 | 2.5 |
| P17 | 496 | 501.6 | 17.1 | 2.8 |
| P18 | 502 | 507 | 17.3 | 2.5 |
| P19 | 508 | 513 | 17.6 | 2.5 |
| P21 | 522 | 527 | 17.2 | 2.5 |
| P22 | 528 | 533 | 17.4 | 2.5 |
| P25 | 550 | 550 | 17.1 | 0 |
| P26 | 550 | 550 | 17.2 | 0 |
| P27 | 550 | 550 | 17.3 | 0 |
| P28 | 550 | 550 | 17.3 | 0 |
| P29 | 550 | 550 | 17.4 | 0 |
| P30 | 550 | 550 | 17.4 | 0 |
| P31 | 550 | 550 | 17.5 | 0 |
| P32 | 550 | 550 | 17.5 | 0 |
| P33 | 550 | 550 | 17.5 | 0 |

In Table 5 above the columns are labelled as follows (see FIGS. 5 and 6 for the dimensions referred to):

WGLO—Waveguide length outer;
WGL1—Waveguide length inner;
WGW—Waveguide width; and
WGSH—Waveguide step height.

The dimensions of waveguides with horn apertures are stated in table 6—see FIG. 6 for the dimensions referred to.

TABLE 6
Dimensions of waveguides with horn apertures for
the 170 cm antenna

| | | P1 | P2 | P3 | P4 | P5 | P6 | P7 | P9 | P10 | P12 | P14 | P16 | P20 | P23 | P24 |
|---|---|---|---|---|---|---|---|---|---|---|---|---|---|---|---|---|
| WG- | WGL | 16 | 58 | 110 | 162 | 208 | 240 | 268 | 306 | 328 | 358 | 382 | 424 | 430 | 474 | 458 |
| length: | | | | | | | | | | | | | | | | |
| Step | SL | 11 | 11 | 11 | 11 | 11 | 11 | 11 | 11 | 11 | 11 | 11 | 11 | 11 | 11 | 11 |
| length: | | | | | | | | | | | | | | | | |
| Inner | IHL | 50.5 | 55.5 | 55.5 | 52.5 | 44.5 | 44.5 | 42.5 | 39.5 | 39.5 | 37.5 | 36.5 | 35.5 | 33.5 | 33.5 | 34 |
| horn | | | | | | | | | | | | | | | | |
| length: | | | | | | | | | | | | | | | | |
| 0uter | OHL | 30 | 30 | 30 | 30 | 30 | 30 | 30 | 30 | 30 | 30 | 30 | 30 | 30 | 30 | 30 |
| horn | | | | | | | | | | | | | | | | |
| length: | | | | | | | | | | | | | | | | |
| Side | SHW | 33.0 | 33.0 | 33.0 | 33.0 | 33.0 | 33.0 | 33.0 | 33.0 | 33.0 | 33.0 | 33.0 | 33.0 | 33.0 | 33.0 | 33.0 |
| horn | | | | | | | | | | | | | | | | |
| width: | | | | | | | | | | | | | | | | |
| Inner | IHW | 33.0 | 33.0 | 33.0 | 33.0 | 33.0 | 33.0 | 33.0 | 33.0 | 33.0 | 33.0 | 33.0 | 33.0 | 33.0 | 33.0 | 33.0 |
| horn | | | | | | | | | | | | | | | | |
| width: | | | | | | | | | | | | | | | | |
| Outer | OHW | 34.0 | 34.0 | 34.0 | 34.5 | 34.5 | 34.5 | 34.5 | 34.5 | 35 | 35 | 35.5 | 35.5 | 36 | 36.5 | 37 |
| horn | | | | | | | | | | | | | | | | |
| width: | | | | | | | | | | | | | | | | |
| WG | WGW | 17.9 | 18.1 | 18.1 | 18.1 | 18.1 | 17.9 | 17.4 | 17.9 | 17.3 | 17.3 | 17.2 | 17.4 | 17.3 | 17.3 | 17.3 |
| width: | | | | | | | | | | | | | | | | |
| Step | SW1 | 4.2 | 4.2 | 4.2 | 4.2 | 4.2 | 4.2 | 4.2 | 4.2 | 4.2 | 4.2 | 4.2 | 4.2 | 4.2 | 4.2 | 4.2 |
| width1: | | | | | | | | | | | | | | | | |
| Step | SW2 | 5.6 | 5.6 | 5.6 | 5.6 | 5.6 | 5.6 | 5.6 | 5.6 | 5.6 | 5.6 | 5.6 | 5.6 | 5.6 | 5.6 | 5.6 |
| width | | | | | | | | | | | | | | | | |
| 2: | | | | | | | | | | | | | | | | |
| Step | SW3 | 6.6 | 6.6 | 6.6 | 6.6 | 6.8 | 6.9 | 7.2 | 6.8 | 7.2 | 7.2 | 6.55 | 7.0 | 7.2 | 7.2 | 7.2 |
| width | | | | | | | | | | | | | | | | |
| 3: | | | | | | | | | | | | | | | | |
| Step | SW4 | 5.8 | 5.8 | 5.8 | 5.8 | 5.8 | 5.8 | 5.8 | 5.8 | 5.8 | 5.8 | 5.8 | 5.8 | 5.8 | 5.8 | 5.8 |
| width | | | | | | | | | | | | | | | | |
| 4: | | | | | | | | | | | | | | | | |
| Step | SW5 | 5.8 | 5.8 | 5.8 | 5.8 | 5.8 | 5.8 | 5.8 | 5.8 | 5.8 | 5.8 | 5.8 | 5.8 | 5.8 | 5.8 | 5.8 |
| width | | | | | | | | | | | | | | | | |
| 5: | | | | | | | | | | | | | | | | |
| Step | SW6 | 4.2 | 4.2 | 4.2 | 4.2 | 4.2 | 4.2 | 4.2 | 4.2 | 4.2 | 4.2 | 4.2 | 4.2 | 4.2 | 4.2 | 4.2 |
| width | | | | | | | | | | | | | | | | |
| 6: | | | | | | | | | | | | | | | | |
| Step | SW7 | 4.2 | 4.2 | 4.2 | 4.2 | 4.2 | 4.2 | 4.2 | 4.2 | 4.2 | 4.2 | 4.2 | 4.2 | 4.2 | 4.2 | 4.2 |
| width | | | | | | | | | | | | | | | | |
| 7: | | | | | | | | | | | | | | | | |

The waveguides are typically located substantially parallel to one another, giving the advantage of easier manufacture and assembly.

The dimensions given above provide a wide band waveguide lens antenna with the advantage that there is near zero group delay across the required frequencies (10-14 GH₂) which allows wideband transmission and reception. The use of Fresnel steps allows the lightweight construction, as do the hollow waveguides and EPS horns.

The waveguide lens as described above advantageously causes some blur of incoming frequencies, so that different frequencies of incoming wavefronts are all focused in the same general space in the horn. In this way, the lens makes use of the frequency distribution of phase centres of the horn.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

1. A waveguide lens comprises a plurality of waveguides, the lens being adapted to focus an incoming wavefront to a chosen focal plane and to blur an outgoing wave front emitted from the focal plane, wherein each waveguide comprises a waveguide pipe, said waveguide pipes having longitudinal axes arranged substantially parallel to each other.

2. A waveguide lens as claimed in claim 1, in which the waveguide pipes are hollow.

3. A waveguide lens as claimed in claim 1, in which the waveguide pipes have an electrically conducting coating on at least one of an interior or an exterior surface thereof.

4. A waveguide lens as claimed in claim 1, in which the waveguides incorporate at least one waveguide horn.

5. A waveguide lens as claimed in claim 4, in which the waveguide horn has an electrically conducting coating on side walls thereof.

6. A waveguide lens as claimed in claim 4, in which the waveguide horns flare away from the ends of the waveguide pipe.

7. A waveguide lens as claimed in claim 1, in which the waveguide lens is a wideband waveguide lens.

8. A waveguide lens as claimed in claim 1, which has an operating range, defined by (fmax−fmin/fcentre)*100, in the range 10% to 40%.

9. A waveguide lens as claimed in claim 1, which is a convex waveguide lens.

10. A waveguide lens as claimed in claim 1, in which the waveguides are arranged in zones centered on a central axis of the lens.

11. A waveguide lens as claimed in claim 10, in which the zones of waveguides have equal time delay in each zone.

12. A waveguide lens comprises a plurality of waveguides, wherein the waveguide lens is adapted to focus an incoming wavefront to a focal space, to thereby cause different frequencies of incoming wavefront to be focused to substantially the same focal space.

13. A waveguide lens, as claimed in claim 12, in which the waveguide lens focuses the incoming wavefront to allow multiple frequencies to be picked up by a horn located in the focal space.

14. An assembly comprises a waveguide lens with a focal space and at least one transmitting/receiving horn.

15. The assembly of claim 14, in which the at least one transmitting/receiving horn has phase centres that substantially coincide with the focal space of the waveguide lens.
